(19) United States
(12) Patent Application Publication
(10) Pub. No.: US 2024/0215586 A1
(43) Pub. Date: Jul. 4, 2024

(54) VIRUS-INACTIVATING LIQUID AGENT AND VIRUS-INACTIVATING ARTICLE

(71) Applicant: Murata Manufacturing Co., Ltd., Nagaokakyo-shi (JP)

(72) Inventors: Yuusuke Ogawa, Nagaokakyo-shi (JP); Takeshi Torita, Nagaokakyo-shi (JP); Ichitaro Okamura, Nagaokakyo-shi (JP); Gerald Lee Kolbe, Port Matilda, PA (US)

(21) Appl. No.: 18/337,547

(22) Filed: Jun. 20, 2023

Related U.S. Application Data
(63) Continuation of application No. PCT/JP2021/046578, filed on Dec. 16, 2021.
(60) Provisional application No. 63/129,051, filed on Dec. 22, 2020.

(51) Int. Cl. A01N 59/16; A01N 25/34; A01P 1/00

(52) U.S. Cl. CPC A01N 59/16; A01N 25/34; A01P 1/00

(57) ABSTRACT

A virus-inactivating liquid agent that includes: a liquid medium; and particles of a layered material including one or plural layers, wherein the one or plural layers include a layer body represented by: MmXn, wherein M is at least one metal of Group 3, 4, 5, 6, or 7; X is a carbon atom, a nitrogen atom, or a combination thereof; n is 1 to 4; m is more than n and 5 or less; and a modifier or terminal T exists on a surface of the layer body, and T is at least one of a hydroxyl group, a fluorine atom, a chlorine atom, or an oxygen atom.

### CROSS REFERENCE TO RELATED APPLICATIONS

The present application is a continuation of International application No. PCT/JP2021/046578, filed Dec. 16, 2021, which claims priority to U.S. Provisional Patent Application No. 63/129,051, filed Dec. 22, 2020, the entire contents of each of which are incorporated herein by reference.

### FIELD OF THE INVENTION

The present disclosure relates to a virus-inactivating liquid agent and a virus-inactivating article.

### BACKGROUND OF THE INVENTION

In the related art, various antibacterial agents and articles to which the antibacterial agents are applied have been known. For example, Patent Document 1 discloses an antibacterial sheet in which silver is used as an active ingredient of an antibacterial agent, and an antibacterial layer containing the antibacterial agent and a binder (water contact angle of binder alone is 20° or less) is disposed on a substrate. Patent Document 1 discloses that an antimicrobial agent that exhibits a bactericidal effect against pathogenic bacteria represented by Staphylococcus aureus and Escherichia coli is suitably used.

On the other hand, it has been known that the virus-inactivating liquid agent contains an alcohol such as ethanol or 2-propanol as an active ingredient. The WHO (World Health Organization) recommends a formulation with an alcohol concentration of 80 vol % ethanol or 75 vol % 2-propanol as a hand sanitizer. However, it has been reported that the effect of virus inactivation is obtained even with a formulation having a lower alcohol concentration than the one described above. For example, Non-Patent Document 1 reports that the effect of virus inactivation is obtained by a formulation in which the concentration of ethanol or 2-propanol is 30 vol %, with respect to SARS-CoV-2 (so-called “novel coronavirus”).
Patent Document 1: WO 2016/047568 A
Patent Document 2: WO 2017/083055 A
Non-Patent Document 1: Annika Kratzel, et al., “Inactivation of Severe Acute Respiratory Syndrome Coronavirus 2 by WHO-Recommended Hand Rub Formulations and Alcohols”, Emerging Infectious Diseases, 2020, Vol. 26, Issue 7, pp. 1592-1595

### SUMMARY OF THE INVENTION

In recent years, MXene has been attracting attention as a new material. MXene is a type of so-called two-dimensional material, and as will be described later, is a layered material in the form of one or plural layers. In general, MXene is in the form of particles (which can include powders, flakes, nanosheets, and the like) of such a layered material.

Patent Document 2 discloses an antimicrobial agent containing MXene and an antimicrobial membrane in which the antimicrobial agent is coated on a polyvinylidene fluoride (PVDF) substrate. Patent Document 2 discloses that such an antibacterial agent has an antibacterial effect on each of bacteria of Escherichia coli (E. coli) and Bacillus subtilis (B. subtilis).

As is generally known, bacteria are single-cell organisms, have a size on the order of microns, and are capable of self-growth. In contrast, viruses are composed of nucleic acids (genes) and capsids, and optionally an envelope, have a size on the order of nanometers, are not capable of self-propagation, and are parasitic and proliferate in cells (hosts). As described above, bacteria and viruses are completely different from each other at least in terms of structure, size, and proliferation mechanism. Even if a certain substance exhibits an antibacterial effect, it cannot be determined whether the substance exhibits an effect of virus inactivation only by that fact. In fact, Patent Documents 1 and 2 do not mention any virus. The antibacterial properties can be evaluated according to JIS Z 2801, for example, as disclosed in Patent Document 1. The virus inactivation ability is not specified, but can be evaluated by the TCID₅₀ method as disclosed in Non-Patent Document 1, for example.

There are various types of viruses, and preventing the spread of infectious diseases caused by viruses is an extremely important issue in the international community. Under such circumstances, there is an increasing demand for novel virus-inactivating liquid agents and virus-inactivating articles.

An object of the present disclosure is to provide a novel virus-inactivating liquid agent and a virus-inactivating article.

As a result of intensive studies, the present inventors have uniquely found that MXene has virus inactivation ability, thereby completing the present disclosure.

According to a first gist of the present disclosure, there is provided a virus-inactivating liquid agent comprising: a liquid medium; and particles of a layered material including one or plural layers, wherein the one or plural layers include a layer body represented by: MₘXₙ, wherein M is at least one first metal of Group 3, 4, 5, 6, or 7; X is a carbon atom, a nitrogen atom, or a combination thereof; n is 1 to 4; m is more than n and 5 or less; and a modifier or terminal T exists on a surface of the layer body, wherein T is at least one selected from the group consisting of a hydroxyl group, a fluorine atom, a chlorine atom, or an oxygen atom.

In one aspect of the first gist of the present disclosure, the MₘXₙ may be Ti₃C₂.

In one aspect of the first gist of the present disclosure, an average value of thicknesses of the particles may be 10 nm or less.

In one aspect of the first gist of the present disclosure, the liquid medium may contain at least one of water and alcohol.

In one aspect of the first gist of the present disclosure, the virus-inactivating liquid agent may further comprise at least one additive selected from the group consisting of a dispersant, a binder, an antioxidant, a viscosity modifier, or a perfume.

In one aspect of the first gist of the present disclosure, a content of the particles in the virus-inactivating liquid agent may be 0.5 mg/mL to 100 mg/mL.

In one aspect of the first gist of the present disclosure, the liquid medium may have a pH of 2.7 to 7.0.

In one aspect of the first gist of the present disclosure, the particles further include Li, and a content of Li in the particles may be 20 ppm by mass or less.

In one aspect of the first gist of the present disclosure, a total content of chlorine and bromine in the particles may be 1,500 ppm by mass or less.

In one aspect of the first gist of the present disclosure, the particles may carry at least one of a second metal and a metal oxide. For example, the particles may carry titanium oxide.

According to a second gist of the present disclosure, there is provided a virus-inactivating article comprising: a substrate; and a virus-inactivating layer disposed on the substrate, wherein the virus-inactivating layer includes particles of a layered material including one or plural layers, the one or plural layers including a layer body represented by: MₘXₙ, wherein M is at least one first metal of Group 3, 4, 5, 6, or 7, X is a carbon atom, a nitrogen atom, or a combination thereof; n is 1 to 4; m is more than n and 5 or less; and a modifier or terminal T exists on a surface of the layer body, wherein T is at least one selected from the group consisting of a hydroxyl group, a fluorine atom, a chlorine atom, or an oxygen atom.

In one aspect of the second gist of the present disclosure, the substrate may be any one selected from the group consisting of a filter, a mask, a face shield, a bandage, a glove, a gown, a touch panel, a display, a film, or a sticker.

In one aspect of the second gist of the present disclosure, the MₘXₙ may be Ti₃C₂.

In one aspect of the second gist of the present disclosure, an average value of thicknesses of the particles may be 10 nm or less.

In one aspect of the second gist of the present disclosure, the virus-inactivating article may further comprise at least one additive selected from the group consisting of a dispersant, a binder, an antioxidant, a viscosity modifier, or a perfume.

In one aspect of the second gist of the present disclosure, the particles further include Li, and a content of Li in the particles may be 20 ppm by mass or less.

In one aspect of the second gist of the present disclosure, a total content of chlorine and bromine in the particles may be 1,500 ppm by mass or less.

In one aspect of the second gist of the present disclosure, the particles may carry at least one of a second metal and a metal oxide. For example, the particles may carry titanium oxide.

According to the present disclosure, the virus-inactivating liquid agent and the virus-inactivating layer of the virus-inactivating article include particles of a predetermined layered material (also referred to herein as “MXene”), whereby the virus can be inactivated. Therefore, according to the present disclosure, a novel virus-inactivating liquid agent and a virus-inactivating article are provided.

### BRIEF DESCRIPTION OF THE DRAWINGS

FIG. 1 is a schematic cross-sectional view illustrating MXene which is a layered material usable in one embodiment of the present disclosure, in which FIG. 1(a) illustrates single-layer MXene, and FIG. 1(b) illustrates multilayer (exemplarily two-layer) MXene.

FIG. 2 is a diagram illustrating a virus-inactivating article in one embodiment of the present disclosure, in which FIG. 2(a) illustrates a schematic cross-sectional view of the virus-inactivating article, and FIG. 2(b) illustrates a schematic perspective view of a layered material in the virus-inactivating layer of the virus-inactivating article.

FIG. 3 is a SEM photograph showing that partial oxidation proceeds in heat treatment (oxidation treatment) of Example 2, in which FIG. 3(a) is a SEM photograph of a solid content (particle) before the treatment, and FIG. 3(b) is a SEM photograph of a solid content (particle) after the treatment.

### DETAILED DESCRIPTION OF THE PREFERRED EMBODIMENTS

### First Embodiment: Virus-Inactivating Liquid Agent

Hereinafter, a virus-inactivating liquid agent in one embodiment of the present disclosure will be described in detail, but the present disclosure is not limited to such an embodiment.

The virus-inactivating liquid agent of the present embodiment contains a liquid medium and particles of a predetermined layered material.

A predetermined layered material that can be used in the present embodiment is MXene and is defined as:

a layered material (this can be understood as a layered compound, also represented as “MₘXₙT₅”, where s is any number and traditionally x is sometimes used instead of s) including one or plural layers, the one or plural layers including a layer body (the layer body may have a crystal lattice in which each X is located in an octahedral array of M) represented by:

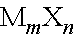

(wherein M is at least one metal of Group 3, 4, 5, 6, or 7 and may contain at least one selected from the group consisting of so-called early transition metals such as Sc, Ti, Zr, Hf, V, Nb, Ta, Cr, Mo, or Mn; X is a carbon atom, a nitrogen atom, or a combination thereof; n is 1 to 4; and m is more than n and 5 or less) and a modifier or terminal T (T is at least one selected from the group consisting of a hydroxyl group, a fluorine atom, a chlorine atom, or an oxygen atom) present on the surface (more specifically, at least one of the two opposing surfaces of the layer body) of the layer body. Typically, n can be 1, 2, 3, or 4, but is not limited thereto.

In the above formula of MXene, M is preferably at least one selected from the group consisting of Ti, Zr, Hf, V, Nb, Ta, Cr, Mo, or Mn, and more preferably at least one selected from the group consisting of Ti, V, Cr, or Mo.

MXenes whose above formula MmXn is expressed as below are known:
Sc₂C, Ti₂C, Ti₂N, Zr₂C, Zr₂N, Hf₂C, Hf₂N, V₂C, V₂N, Nb₂C, Ta₂C, Cr₂C, Cr₂N, Mo₂C, Mo_{1.3}C, Cr_{1.3}C, (Ti,V)₂C, (Ti,Nb)₂C, W₂C, W_{1.3}C, Mo₂N, Nb_{1.3}C, Mo_{1.3}Y_{0.6}C (in the above formula, “1.3” and “0.6” mean about 1.3 (=4/3) and about 0.6 (=2/3), respectively),
Ti₃C₂, Ti₃N₂, Ti₃(CN), Zr₃C₂, (Ti,V)₃C₂, (Ti₂Nb)C₂, (Ti₂Ta)C₂, (Ti₂Mn)C₂, Hf₃C₂, (Hf₂V)C₂, (Hf₂Mn)C₂, (V₂Ti)C₂, (Cr₂Ti)C₂, (Cr₂V)C₂, (Cr₂Nb)C₂, (Cr₂Ta)C₂, (Mo₂Sc)C₂, (Mo₂Ti)C₂, (Mo₂Zr)C₂, (Mo₂Hf)C₂, (Mo₂V)C₂, (Mo₂Nb)C₂, (Mo₂Ta)C₂, (W₂Ti)C₂, (W₂Zr)C₂, (W₂Hf)C₂,
Ti₄N₃, V₄C₃, Nb₄C₃, Ta₄C₃, (Ti,Nb)₄C₃, (Nb,Zr)₄C₃, (Ti₂Nb₂)C₃, (Ti₂Ta₂)C₃, (V₂Ti₂)C₃, (V₂Nb₂)C₃, (V₂Ta₂)C₃, (Nb₂Ta₂)C₃, (Cr₂Ti₂)C₃, (Cr₂V₂)C₃, (Cr₂Nb₂)C₃, (Cr₂Ta₂)C₃, (Mo₂Ti₂)C₃, (Mo₂Zr₂)C₃, (Mo₂Hf₂)C₃, (Mo₂V₂)C₃, (Mo₂Nb₂)C₃, (Mo₂Ta₂)C₃, (W₂Ti₂)C₃, (W₂Zr₂)C₃, (W₂Hf₂)C₃.

Typically in the above formula, M can be titanium or vanadium and X can be a carbon atom or a nitrogen atom. For example, the MAX phase is Ti₃AlC₂ and MXene is Ti₃C₂T₅ (in other words, M is Ti, X is C, n is 2, and m is 3). That is, the above formula:

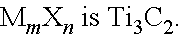

Such MXene particles (hereinafter, the particles are simply referred to as “MXene particles”) can be synthesized by selectively etching (removing and optionally layer-separating) A atoms (and optionally a part of M atoms) from a MAX phase. The MAX phase is represented by:

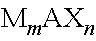

(wherein M, X, n, and m are as described above, and A is at least one element of Group 12, 13, 14, 15, or 16, is usually a Group A element, typically Group IIIA and Group IVA, more specifically, may include at least one selected from the group consisting of Al, Ga, In, Tl, Si, Ge, Sn, Pb, P, As, S, or Cd, and is preferably Al), and has a crystal structure in which a layer formed of A atoms is located between two layers (each X may have a crystal lattice located within an octahedral array of M) represented by MmXn. Typically, in the case of m=n+1, the MAX phase has a repeating unit in which one layer of X atoms is disposed between the layers of M atoms of n+1 layers (these layers are also collectively referred to as “MₘXₙ layer”), and a layer of A atoms (“A atom layer”) is disposed as a next layer of the (n+1) th layer of M atoms; however, the present invention is not limited thereto. By selectively etching (removing and optionally layer-separating) the A atoms (and optionally a part of the M atoms) from the MAX phase, the A atom layer (and optionally a part of the M atoms) is removed, and a hydroxyl group, a fluorine atom, a chlorine atom, an oxygen atom, and the like existing in an etching solution (usually, an aqueous solution of a fluorine-containing acid is used, but not limited thereto) are modified on the exposed surface of the MmXn layer, thereby terminating the surface.

In the etching, an etching treatment is performed with an acid such as HF, HCl, HBr, HI, sulfuric acid, phosphoric acid, or nitric acid using a fluororesin container. Particularly, the etching can be carried out using an etching solution containing F⁻, and a method using, for example, a mixed liquid of lithium fluoride and hydrochloric acid, a method using hydrofluoric acid, or the like may be used.

If desired, any suitable metal (for example, Li) or the like may be inserted (intercalated) between the MXene layers. The intercalation treatment may be separately performed after the etching treatment, or may be performed together with the etching treatment.

Thereafter, the layer separation (delamination, separating multilayer MXene into single-layer MXene) of MXene may be promoted by any appropriate post-treatment (for example, ultrasonic treatment, handshaking, automatic shaker, or the like) as appropriate. For example, the delamination treatment can be performed for a predetermined time using a mechanical shaker, a vortex mixer, a homogenizer, an ultrasonic bath, or the like. Subsequently, the supernatant and the precipitate are separated by a centrifugal separator, and the recovered supernatant can be obtained as a dispersion of MXene particles in a single-layer form. Since the shear force of an ultrasonic treatment is too large so that the MXene can be destroyed, it is desirable to apply appropriate shear force by handshake, an automatic shaker or the like, when it is desired to obtain two-dimensional MXene particles (preferably single-layer MXene particles) having a larger aspect ratio.

It is noted, in the present disclosure, MXene particles may contain remaining A atoms at a relatively small amount, for example, at 10 mass % or less with respect to the original amount of A atoms. The remaining amount of A atoms can be preferably 8 mass % or less, and more preferably 6 mass % or less. However, even if the residual amount of A atoms exceeds 10 mass %, there may be no problem depending on the application and use conditions of virus inactivation.

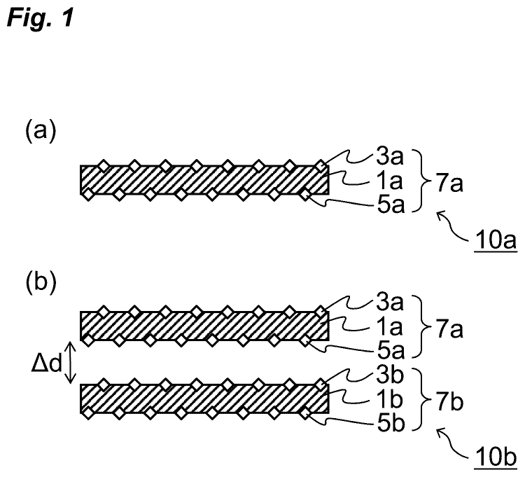

As schematically illustrated in FIG. 1, the MXene particles 10 synthesized in this manner may be particles of a layered material (as examples of the MXene particles 10, the MXene particles 10a in one layer are illustrated in FIG. 1(a), and the MXene particles 10b in two layers are illustrated in FIG. 1(b), but the present invention is not limited to these examples) including one or plural MXene layers 7a and 7b. More specifically, the MXene layers 7a and 7b have layer bodies (MₘXₙ layers) 1a and 1b represented by MₘXₙ, and modifiers or terminals T 3a, 5a, 3b, and 5b existing on the surfaces of the layer bodies 1a and 1b (more specifically, on at least one of two surfaces, facing each other, of each layer). Therefore, the MXene layers 7a and 7b are also represented by “MₘXₙT₅”, wherein s is any number. The MXene particles 10 may be one in which such MXene layers are individually separated and exist in one layer (the single-layer structure illustrated in FIG. 1(a), so-called single-layer MXene particles 10a), a laminate in which a plurality of MXene layers are stacked apart from each other (the multilayer structure illustrated in FIG. 1(b), so-called multilayer MXene particles 10b), or a mixture thereof. The MXene particles 10 may be particles (which may also be referred to as powders or flakes) as an aggregate formed of the single-layer MXene particles 10a and/or the multilayer MXene particles 10b. In the case of multilayer MXene particles, two adjacent MXene layers (for example, 7a and 7b) do not necessarily have to be completely separated from each other, and may be partially in contact with each other. In the present embodiment, as will be described later, the MXene particles 10 preferably include as many single-layer MXene particles as possible (the content ratio of the single-layer MXene particles is high) as compared with the multilayer MXene particles.

Although not limiting the present embodiment, the thickness of each layer (which corresponds to the MXene layers 7a and 7b) of MXene particles is, for example, 0.8 nm to 5 nm, and particularly 0.8 nm to 3 nm (which can vary mainly depending on the number of M atom layers included in each layer), and the maximum dimension in a plane (two-dimensional sheet plane) parallel to the layer is, for example, 0.1 μm to 200 μm, and particularly 1 μm to 40 μm.

When the MXene particles are laminate (multilayer MXene) particles, for each laminate, an interlayer distance (alternatively, a void dimension, indicated by Δd in FIG. 1(b)) is, for example, 0.8 nm to 10 nm, particularly 0.8 nm to 5 nm, and more particularly about 1 nm, and the maximum dimension in a plane (two-dimensional sheet plane) perpendicular to the stacking direction is, for example, 0.1 μm to 100 μm, and particularly 1 μm to 20 μm.

The total number of layers in the MXene particles may be 1 or 2 or more, but is, for example, 1 to 100,000, and particularly, 1,000 to 20,000, the thickness in the stacking direction is, for example, 0.1 μm to 200 μm and particularly, 1 μm to 40 μm.

In a case where MXene particles are particles of the laminates (multilayer MXene), it is preferable that MXene particles have a small number of layers. The term “small number of layers” means, for example, that the number of stacked layers of MXene particles is 6 or less. The thickness, in a stacking direction, of the multilayer MXene particles having a few layers is preferably 10 nm or less. In the present specification, the “multilayer MXene having a few layers” (multilayer MXene in a narrow sense) is also referred to as a “few-layer MXene”.

In the present embodiment, the MXene particles are preferably particles (also referred to as nanosheets) in which most of the MXene particles are formed of single-layer MXene and/or few-layer MXene. In the present specification, the single-layer MXene and the small number of layers MXene may be collectively referred to as “single-layer/few-layer MXene”.

In other words, the average value of the thicknesses of the MXene particles is preferably 10 nm or less. The average value of the thickness is more preferably 7 nm or less, and still more preferably 5 nm or less. On the other hand, in consideration of the thickness of the single-layer MXene particles, the lower limit of the thickness of the MXene particles can be 1.0 nm. Therefore, the average value of the thickness of the MXene particles can be 1 nm or more.

From another viewpoint, the proportion of particles having a thickness of 10 nm or less in the stacking direction (single-layer MXene particles and/or few-layer MXene particles) in the entire MXene particles is preferably 90 vol % or more, and more preferably 95 vol % or more.

It should be noted that these dimensions described above may be determined as number average dimensions (for example, number average of at least 40) based on photographs of a scanning electron microscope (SEM), a transmission electron microscope (TEM), or an atomic force microscope (AFM), or as distances in the real space calculated from the positions on the reciprocal lattice space of the (002) plane measured by an X-ray diffraction (XRD) method.

On the other hand, any suitable liquid can be used as a liquid medium. For example, the liquid medium may be an aqueous medium. The aqueous medium is typically water, and in some cases, other liquid substances may be contained in a relatively small amount (for example, 30 mass % or less, preferably 20 mass % or less based on the whole mass of aqueous medium) in addition to water. The liquid medium can be understood as a dispersion medium capable of dispersing MXene particles. A solute such as an ion may be dissolved in the liquid medium.

For example, the liquid medium may contain at least one of water and alcohol. Typically, the liquid medium is preferably water or a mixture of water and alcohol. The alcohol is not particularly limited, and may be, for example, methanol, ethanol, propanol (1-propanol, 2-propanol), or the like. When alcohol (methanol, ethanol, propanol, or the like) soluble/miscible in water is used in the mixture of water and alcohol, the content of the alcohol based on the entire liquid medium is not particularly limited, and can be appropriately selected according to the use mode of the virus-inactivating liquid agent and the like.

If the combustible/flammable risk can be a problem in the application of the virus-inactivating liquid agent, the liquid medium is preferably water or a mixture of water and a relatively small amount of alcohol, more preferably water. Water is non-flammable and has no combustible/flammable risk like alcohol. On the other hand, in the case of a known common alcohol-based antiseptic solution (containing alcohol such as ethanol as an active ingredient), the flash point can be within the range of room temperature, although depending on the type and concentration of alcohol, and there is a flammable risk if there is an ignition source.

The virus-inactivating liquid agent of the present embodiment may further contain other components. For example, the virus-inactivating liquid agent may further contain at least one additive selected from the group consisting of a dispersant, a binder, an antioxidant, a viscosity modifier, or a perfume. The dispersant may be added to increase the dispersibility of the MXene particles in the liquid medium. After the virus-inactivating liquid agent is applied to the object and dried (the liquid medium is at least partially removed), the binder may be added to increase the fixing strength between the MXene particles and the object (the substrate in a second embodiment to be described later) or to increase the strength of the virus-inactivating layer itself that can be formed from the virus-inactivating liquid agent. An antioxidant may be added if it is desired to prevent oxidation (more specifically, oxidation of metal (M) constituting MXene layer) of the MXene particles. A viscosity modifier can be added to adjust the viscosity of the virus-inactivating liquid agent. More specific examples of the additive include polyurethane (PU), polyvinyl alcohol (PVA), polyethylene dioxythiophene (PEDOT), sodium alginate (SA), a polyamide resin (for example, nylon), an epoxy resin, an acrylic resin, sodium hexametaphosphate, and polyallylamine.

Such other components may be added/mixed at any suitable timing in the process of making the virus-inactivating liquid agent. For example, other components may be added to a mixture (typically a slurry) containing synthesized MXene particles in a liquid medium, or may be added to the synthesized MXene particles (typically a clay or powder) with the liquid medium.

The virus-inactivating liquid agent of the present embodiment contains MXene particles having virus inactivation ability as an active ingredient. It is a finding uniquely obtained by the present inventors that MXene particles have the virus inactivation ability. Although the present disclosure is not bound by any theory, the mechanism by which the MXene particles inactivate the virus is considered as follows. The MXene particles have modifiers or terminals T (T is at least one selected from the group consisting of a hydroxyl group, a fluorine atom, a chlorine atom, or an oxygen atom) on the surface of the layer body represented by MₘXₙ, and a charged site (negative or positive charge) in such a configuration exists. Without limiting the present disclosure, specifically, the MXene particles may be negatively charged at planar (two-dimensional sheet surface) portions parallel to the layer and positively charged at the ends of the layer of MXene particles. Generally, viruses can also have a charge (for example, a positive charge) and are adsorbed by Coulomb force to the oppositely charged (for example, negative charge) sites present in the MXene particles. Since the MXene particles have conductivity, when the virus is adsorbed to the site of the MXene particles, the virus is electrically neutralized, and as a result, the virus is immediately inactivated.

The mechanism in which the MXene particles inactivate the virus is fundamentally different from the mechanism in which the MXene particles exhibit an antibacterial effect (suppress bacterial growth). Bacteria have a size comparable to or greater than that of MXene particles. Therefore, the bacteria are surrounded by a plurality of MXene particles (instead of being adsorbed to the MXene particles like viruses). In such a state, the effect of the specific site of the MXene particles on bacteria is very small (compared to the effect on viruses). Furthermore, since the bacteria have a cell wall and a cell membrane, the bacteria are not prevented from proliferating immediately by being surrounded by a plurality of MXene particles, but are gradually inhibited from proliferating due to inhibition of life support activities such as nutrient intake.

From the above mechanism in which the MXene particles inactivate the virus, it is considered that the larger the specific surface area of the MXene particles, the higher the contact probability with the virus, and the higher the virus inactivation effect can be exhibited. Although the present embodiment is not limited, from such a viewpoint, the MXene particles are preferably single-layer/few-layer MXene particles, and the average value of the thicknesses of the MXene particles is preferably 10 nm or less.

The virus is not particularly limited. Viruses may be composed of nucleic acids (genes) and capsids, and optionally an envelope, and generally have a size on the order of nanometers, for example a size of tens of nanometers to hundreds of nanometers. Examples of enveloped virus (virus having an envelope) include SARS-CoV-2 (so-called “novel coronavirus”), influenza virus, herpes virus, rubella virus, hepatitis B virus, hepatitis C virus, and AIDS virus. Examples of non-enveloped virus (non-enveloped virus) include norovirus, rotavirus, poliovirus, and adenovirus. In the evaluation test of virus inactivation ability, feline calicivirus can be used as a virus alternative to norovirus.

In the present disclosure, “virus inactivation” (or inactivating a virus) means that infectivity of a virus is lost, and can also be expressed as “antiviral”. Specifically, when a viral infectivity titer is evaluated by the TCID₅₀ method, if the viral infectivity titer is below the detection limit, it may be considered that “virus inactivation” has been achieved. The virus inactivation ability (the ability to inactivate a virus) can be understood to be higher the shorter the duration of action required for a viral infectivity titer to be below the limit of detection.

In addition, in the present disclosure, the “liquid agent” means an agent having a liquid form as a whole. The liquid agent may be a dispersion (or suspension) in which the MXene particles are dispersed (or suspended) in a liquid medium, and may be, for example, a sprayable slurry, a dispensable gel, or the like depending on the use mode of the virus-inactivating liquid agent and the like.

The virus-inactivating liquid agent of the present embodiment has high virus inactivation ability, and is capable of virus inactivation in acting time of, for example, one minute or less. In addition, since the virus-inactivating liquid agent of the present embodiment contains MXene particles as an active ingredient, even if the liquid medium is volatilized by being exposed to air after the virus-inactivating liquid agent is applied to an object, the MXene particles remain on the surface of the object, and the effect of virus inactivation can be continuously exerted for a long time, for example, even after 24 hours. On the other hand, in the case of a known common alcohol-based antiseptic solution, when alcohol is volatilized, the effect of virus inactivation cannot be obtained.

The virus-inactivating liquid agent of the present embodiment exhibits a sufficient virus-inactivating effect even when the content of MXene particles as an active ingredient is small. The content of the MXene particles in the virus-inactivating liquid agent can be, for example, 0.5 mg/mL or more, preferably 1 mg/mL or more, and more preferably 5 mg/mL or more. The upper limit of the content of the MXene particles in the virus-inactivating liquid agent can be appropriately selected according to the use mode of the virus-inactivating liquid agent and the like, but when a dilute virus-inactivating liquid agent is desired, the content can be, for example, 100 mg/mL or less, and if necessary, 50 mg/mL or less, and if further necessary, 10 mg/mL or less.

In the virus-inactivating liquid agent of the present embodiment, a pH of the liquid medium can be appropriately selected according to characteristics, applications, and the like desired for the virus-inactivating liquid agent, and can be, for example, 2.7 to 7.0. In a pH range of 2.7 to 7.0, the MXene particles can be stably dispersed in a liquid medium, and aggregation and/or sedimentation of the MXene particles can be prevented or reduced. Dispersion stability is important in using the virus-inactivating liquid agent (for application to an object) and/or in obtaining a desired virus-inactivating effect evenly throughout the virus-inactivating liquid agent (or a virus-inactivating layer or the like formed using the virus-inactivating liquid agent). In order to obtain higher dispersion stability for the MXene particles, the pH of the liquid medium is preferably 2.7 to 6.0.

In particular, the pH of the liquid medium is preferably 3.0 to 5.0. In a pH range of 3.0 to 5.0, in addition to obtaining high dispersion stability for MXene particles, the effect of virus inactivation can be continuously exhibited for a longer time. Although the present disclosure is not bound by any theory, it is considered that the oxidation of MXene particles is stabilized in a pH range of 3.0 to 5.0, thereby obtaining the above effect. At a pH below the neutral range, the MXene particles can be hydrolyzed from the end of the MXene layer, and an oxide of the metal (M) constituting the MXene layer can be generated (for example, in the case of MXene particles represented by Ti₃C₂T₅, TiO₂ may be generated, and CH₄ and/or amorphous carbon may be generated as by-products). That is, the MXene particles are chemically decomposed without maintaining MₘXₙ of the layer body at the portion where the oxidation has occurred, and are covered with the oxide of the metal (M) (hereinafter, such partial oxidation is also simply referred to as “partial oxidation”). Even if partial oxidation occurs in the MXene particles to some extent, the entire charged site of the MXene particles is not lost, so that the effect of virus inactivation is not significantly inactivated. In a pH range of 3.0 to 5.0, partial oxidation of the MXene particles may occur to some extent, but the oxidation is stabilized (in other words, the oxidation apparently does not substantially proceed), so that the effect of virus inactivation can be prevented from being completely inactivated, and the MXene particles can be continuously exhibited at a level sufficient for virus inactivation for a longer time. In addition, it is considered that the fact that the decomposition of the MXene particles does not apparently proceed because the oxidation is stabilized as described above also contributes to obtaining high dispersion stability.

From another point of view, strong acidity may be unpreferable in terms of practicality of the virus-inactivating liquid agent. In this case, the pH of the liquid medium may be 3.0 to 7.0 (weak acidic region pH=3.0 to 6.0, or neutral region pH=more than 6.0 and 7.0 or less).

The pH of the liquid medium can be adjusted by the type and concentration of ions dissolved in the liquid medium. Although the present embodiment is not limited, the pH of the liquid medium in the virus-inactivating liquid agent (typically, the slurry after delamination) obtained subsequently can be adjusted by, for example, the processing conditions of etching and/or intercalation (for example, the type of acid and/or base and the charged concentration). As described above, the intercalation treatment may be separately performed after the etching treatment, or may be performed together with the etching treatment. In addition, for example, the pH of the liquid medium can be adjusted in advance when the synthesized MXene particles (typically, clay or powder obtained by separating as a solid content after water washing) are mixed with the liquid medium.

In the virus-inactivating liquid agent of the present embodiment, the content of Li in the MXene particles is preferably 20 ppm by mass or less. It is known that the presence of Li in a relatively large amount can affect a living body, but such a virus-inactivating liquid agent of the present embodiment can have high biocompatibility since the content of Li in MXene particles is 20 ppm by mass or less. The lower limit of the content of Li in the MXene particles is not particularly limited, and may be zero.

For example, even when intercalation of Li is performed, the content of Li in the MXene particles can be suppressed to 20 ppm by mass or less. In this case, the content of Li in the MXene particles can be, for example, 1 ppm by mass or more.

When intercalation of Li is performed, the virus-inactivating liquid agent in which the Li content is suppressed can be produced, for example, by the following first production method or second production method.

A first production method of a virus-inactivating liquid agent includes:
(a) preparing a precursor formed of a MAX phase;
(b1) performing an etching treatment of removing at least a part of A atoms from the precursor by using an etching solution;
(c) performing Li intercalation treatment including a step of mixing and stirring an etched product obtained by the etching treatment and a Li-containing compound;
(d) performing a delamination treatment, including a step of centrifuging a Li intercalated product obtained by the Li intercalation treatment, discarding a supernatant, and then washing a remaining precipitate with water;
(e) performing an acid treatment, including a step of mixing and stirring a delaminated product obtained by the delamination treatment and an acid solution;
(f) washing an acid-treated product obtained by the acid treatment with water to obtain a MXene particle; and
(g) obtaining a virus-inactivating liquid agent by mixing the obtained MXene particle with a liquid medium. By this production method, a virus-inactivating liquid agent having a Li content in the MXene particles of 0.0020 mass % (20 ppm by mass) or less can be produced.

A second production method of a virus-inactivating liquid agent includes:
(a) preparing a precursor formed of a MAX phase;
(b2) etching at least a part of A atoms from the precursor by using an etching solution containing a Li-containing compound and performing a Li intercalation treatment;
(d) performing a delamination treatment, including a step of centrifuging a (etched+Li intercalated) product obtained by etching and the Li intercalation treatment, discarding a supernatant, and then washing a remaining precipitate with water;
(e) performing an acid treatment, including a step of mixing and stirring a delaminated product obtained by the delamination treatment and an acid solution;
(f) washing an acid-treated product obtained by the acid treatment with water to obtain a MXene particle; and
(g) obtaining a virus-inactivating liquid agent by mixing the obtained MXene particle with a liquid medium. By this production method, a virus-inactivating liquid agent having a Li content in the MXene particles of 0.0020 mass % (20 ppm by mass) or less can be produced.

Hereinafter, each step of the first producing method and the second producing method will be described in detail. The step (a) and the steps (d) to (g) common to these two production methods will be collectively described.

### Step (a)

First, a precursor formed of a MAX phase is prepared. The MAX phase is as described above. The precursor may contain a trace amount of impurities inevitably mixed in addition to the MAX phase.

### Step (b1)

In the first production method, an etching treatment is performed to remove at least a part of A atoms from the precursor using an etching solution. The etching treatment is not particularly limited, and known conditions can be adopted. The etching can be performed using an etching solution containing F⁻, and examples thereof include a method using hydrofluoric acid, a method using a mixed liquid of lithium fluoride and hydrochloric acid, and a method using an etching solution further containing phosphoric acid or the like. Examples of these methods include a method using a mixed liquid with pure water as a solvent. Examples of the etched product obtained by the etching treatment include slurry.

### Step (c)

A Li intercalation treatment is performed, which includes a step of mixing and stirring the etched product obtained by the etching treatment and the Li-containing compound.

Examples of the Li-containing compound include metal compounds containing Li ions. As a metal compound containing Li ions, an ionic compound in which a Li ion and a cation are bonded can be used. Examples of the Li ions include an iodide, a phosphate, a sulfide salt including a sulfate, a nitrate, an acetate, and a carboxylate.

The content of the Li-containing compound in a formulation for intercalation treatment is preferably 0.001 mass % or more. The content is more preferably 0.01 mass % or more, and still more preferably 0.1 mass % or more. On the other hand, from the viewpoint of dispersibility in a solution, the content of the Li-containing compound is preferably 10 mass % or less, and more preferably 1 mass % or less.

In the step (c), for example, a moisture medium clay of MXene, as an etched product, obtained by washing the slurry obtained by the etching treatment in the step (b1) by repeating centrifugation, removal of the supernatant, addition of pure water to the remaining precipitate, and centrifugation again may be subjected to the intercalation treatment.

The specific method of the intercalation treatment is not particularly limited, and examples thereof include mixing a Li-containing compound with the moisture medium clay of MXene and stirring the mixture at room temperature.

In the second production method, as described below, the etching treatment of the precursor and the Li intercalation treatment are performed together in step (b2).

### Step (b2)

In the second production method, at least a part of A atoms (and a part of M atoms in some cases) are etched (removed and separated into layers in some cases) from the precursor by using an etching solution containing a Li-containing compound, and the Li intercalation treatment is performed.

In the step (b2), the Li intercalation treatment is performed in which Li ions are inserted between the layers of the MₘXₙ layer at the time of etching (removal and layer separation in some cases) of at least a part of A atoms (and a part of the M atoms in some cases) from the MAX phase.

The content of the Li-containing compound in the etching solution is preferably 0.001 mass % or more. The content is more preferably 0.01 mass % or more, and still more preferably 0.1 mass % or more. On the other hand, from the viewpoint of dispersibility in a solution, the content of the Li-containing compound in the etching solution is preferably 10 mass % or less, and more preferably 1 mass % or less.

The etching solution in the step (b2) may contain a Li-containing compound, and other configurations of the etching solution are not particularly limited, and known conditions can be adopted. For example, as described in the step (b1), the etching can be performed using an etching solution further containing F⁻, and examples thereof include a method using hydrofluoric acid, a method using a mixed liquid of lithium fluoride and hydrochloric acid, and a method using an etching solution further containing phosphoric acid or the like. Examples of these methods include a method using a mixed liquid with pure water as a solvent. Examples of the etched product obtained by the etching treatment include slurry.

Among the first production method and the second production method, according to a production method in which the step (b1) of etching treatment and the step (c) of Li intercalation treatment are separated as in the first production method, MXene is more easily formed into a single layer, which is preferable.

### Step (d)

A Li intercalated product obtained by the Li intercalation treatment in the first production method or a (etched+Li intercalated) product obtained by the etching and the Li intercalation treatment in the second production method is subjected to a delamination treatment including a step of centrifuging, discarding the supernatant, and then washing the remaining precipitate with water. The conditions for delamination treatment are not particularly limited, and delamination can be performed by a known method. Examples of the method include the following method.

For example, a slurry-like Li intercalated product or a (etched+Li intercalated) product is centrifuged to discard the supernatant, and then the remaining precipitate is washed with water. In the step (i), pure water is added to the remaining precipitate after discarding the supernatant, and the mixture is stirred, (ii) centrifuged, and (iii) the supernatant is recovered. This operation of (i) to (iii) is repeated 1 time or more, preferably 2 times to 10 times to obtain a single-layer/few-layer MXene-containing supernatant before an acid treatment as a delaminated product. Alternatively, the supernatant may be centrifuged, the supernatant after centrifugation may be discarded, and a single-layer/few-layer MXene-containing clay before the acid treatment may be obtained as a delaminated product.

### Step (e)

An acid treatment is performed, which includes a step of mixing and stirring the delaminated product (single-layer/few-layer MXene-containing supernatant or single-layer/few-layer MXene-containing clay) obtained by the delamination treatment and an acid solution. The acid used for the acid treatment is not limited, and for example, an inorganic acid such as a mineral acid and/or an organic acid can be used. The acid is preferably only an inorganic acid or a mixed acid of an inorganic acid and an organic acid. The acid is more preferably only an inorganic acid. As the inorganic acid, for example, one or more of hydrochloric acid, sulfuric acid, nitric acid, phosphoric acid, perchloric acid, hydroiodic acid, hydrobromic acid, hydrofluoric acid, and the like can be used. It is preferably one or more of hydrochloric acid and sulfuric acid. Examples of the organic acid include acetic acid, citric acid, oxalic acid, benzoic acid, and sorbic acid. The concentration of the acid solution to be mixed with the delaminated product may be adjusted according to the amount, concentration, and the like of the delaminated product to be treated.

The delaminated product and the acid solution are mixed and stirred. Examples of the stirring method include stirring using a handshake, an automatic shaker, a share mixer, a pot mill, or the like. The degree of stirring such as stirring speed and stirring time may be adjusted according to the amount, concentration, and the like of the delaminated product which is an object to be treated.

When the acid solution is mixed and stirred, heating may or may not be performed. The acid solution may be mixed and stirred without being heated, or may be stirred while being heated in a range in which the liquid temperature is 80° C. or lower.

After the stirring, for example, centrifugation is performed to remove the supernatant, and an acid-treated product can be obtained as a slurry. The operation of mixing and stirring with the acid solution may be performed one or more times. From the viewpoint of further reducing the Li content in the MXene particles, it is preferable to perform the operation of mixing with the acid solution and stirring the mixture 2 times or more, for example, 10 times or less. As an aspect in which the operation of mixing and stirring with the acid solution is performed a plurality of times, steps (i) to (iii) of (i) mixing and stirring the acid solution (the delaminated product or the remaining precipitate obtained in the following (iii)), (ii) centrifuging the stirred product, and (iii) discarding the supernatant after centrifugation are performed within a range of 2 times or more, for example, 10 times or less.

The pH of the acid-treated product obtained by the acid treatment is preferably 2.5 or less. The pH is more preferably 2.0 or less, still more preferably 1.5 or less, and even still more preferably 1.2 or less. The lower limit of the pH is not particularly limited, and is about 1.0. When the pH of the acid-treated product is sufficiently low as described above, the dispersibility of the MXene particles is reduced, and the MXene particles are difficult to handle in the subsequent step. However, according to the method, the problem is solved by performing washing with water in the next step.

In the present disclosure, since Li is actively removed by performing the acid treatment as described above, the Li content in the MXene particles can be further reduced.

### Step (f)

The acid-treated product obtained by the acid treatment is washed with water to obtain MXene particles. The amount of water mixed with the acid-treated product and the washing method are not particularly limited. For example, stirring, centrifugation, and the like may be performed by adding water. Examples of the stirring method include stirring using a handshake, an automatic shaker, a share mixer, a pot mill, or the like. The degree of stirring such as stirring speed and stirring time may be adjusted according to the amount, concentration, and the like of the acid-treated product which is an object to be treated. The washing with water may be performed one or more times. Preferably, washing with water is performed a plurality of times. For example, specifically, steps (i) to (iii) of (i) adding water and stirring (to the acid-treated product or the remaining precipitate obtained in the following (iii)), (ii) centrifuging the stirred product, and (iii) discarding the supernatant after centrifugation are performed within a range of 2 times or more, for example, 10 times or less.

### Step (g)

The MXene particles obtained as described above are mixed with a liquid medium to obtain a virus-inactivating liquid agent. Details of the liquid medium are as described above. When the liquid medium is water, the water used in the washing in step (f) (water used in the final washing when washing with water is performed twice or more) may also serve as the liquid medium used in step (g).

In the obtained virus-inactivating liquid agent, the pH of the liquid medium can be 2.7 to 7.0, and is preferably 2.7 to 6.0, and more preferably 3.0 to 5.0, as described above.

As described above, even when intercalation of Li is performed, it is possible to produce a virus-inactivating liquid agent in which the content of Li in MXene particles is 20 ppm by mass or less.

The content of Li in the MXene particles can be measured by elemental (atomic) analysis such as inductively coupled plasma atomic emission spectrometry (ICP-AES) or X-ray fluorescence analysis (XRF).

In the virus-inactivating liquid agent of the present embodiment, the total content of chlorine and bromine in the MXene particles is preferably 1,500 ppm by mass or less. In the electronic equipment industry and the like, as a part of green procurement, it is required that the content of chlorine and bromine among halogens is suppressed to a certain level or less, that is, “halogen-free”. Since the total content of chlorine and bromine in the MXene particles is suppressed, the virus-inactivating liquid agent according to the present embodiment can be suitably used for applications in which halogen-free is required. The total content of chlorine and bromine is preferably 900 ppm by mass or less, and most preferably 0 ppm by mass or less. The lower limit of the total content of chlorine and bromine in the MXene particles is not particularly limited, and may be zero.

The virus-inactivating liquid agent in which the total content of chlorine and bromine is suppressed can be produced, for example, by the following third production method.

A third production method of a virus-inactivating liquid agent includes:
(a) preparing a precursor formed of a MAX phase;
(b3) etching A atoms from the precursor using an etching solution, the etching solution satisfying at least one selected from the group consisting of an H₃PO₄ concentration of 5.5 M or more, an HI concentration of 5.0 M or more, or an H₂SO₄ concentration of 5.0 M or more; and
(g3) obtaining a virus-inactivating liquid agent by mixing the obtained MXene particle with a liquid medium.

### Step (a)

First, a precursor formed of a MAX phase is prepared. This step is similar to the first production method and the second production method.

### Step (b3)

Etching (removing and layer-separating in some cases) A atoms (and a part of M atoms in some cases) from the precursor using an etching solution. As the etching solution, an etching solution satisfying at least one selected from the group consisting of an H₃PO₄ concentration of 5.5 M or more, an HI concentration of 5.0 M or more, or an H₂SO₄ concentration of 5.0 M or more can be used.

In the step (b3), at least one selected from the group consisting of PO₄³⁻, I, or SO₄²⁻ present in the etching solution is adsorbed and bonded to the surface of the exposed MₘXₙ layer after etching (removing and layer-separating in some cases) the A atoms (and a part of M atoms in some cases) from the MAX phase. It is considered that when these PO₄³⁻ and the like are adsorbed on the surface of the MₘXₙ layer, the distance between the MXene layers is increased due to steric hindrance, and the van der Waals force between the MₘXₙ layers is weakened. As a result, it is considered that the MₘXₙ layer can be easily formed into a single layer without applying strong shear to the multi-layered MₘXₙ layer. In addition, since it is not necessary to apply strong shearing, destruction of the MₘXₙ layer in a plane is suppressed, and as a result, a single-layer MₘXₙ layer having a large two-dimensional surface can be obtained.

The etching solution does not contain hydrochloric acid, that is, does not contain chlorine atoms. The phrase “does not contain chlorine atoms” of etching solution means that the chlorine concentration in the etching solution is, for example, 10 ppm by mass or less as measured by combustion-ion chromatography.

The etching solution does not contain hydrochloric acid, and may contain at least one of the predetermined amounts of H₃PO₄ and the like, and other configurations of the etching solution are not particularly limited, and known conditions can be adopted. For example, the method can be performed using an etching solution further containing F⁻, and examples thereof include a method using a mixed solution of hydrofluoric acid (HF) and at least one of the predetermined amounts of H₃PO₄ and the like. The concentration of hydrofluoric acid in the mixed solution may be 1 mass % to 50 mass %.

The H₃PO₄ concentration, the HI concentration, and the H₂SO₄ concentration in the etching solution are preferably as high as possible, and thus the upper limit thereof is not particularly limited, but for example, the H₃PO₄ concentration can be 13.2 M or less, the HI concentration can be 6.5 M or less, and the H₂SO₄ concentration can be 16.5 M or less.

The step after the etching is not particularly limited, and MXene particles can be obtained by a known method. For example, the slurry after the etching is repeatedly washed by repeating centrifugation, removal of the supernatant, addition of pure water to the remaining precipitate, and centrifugation again, and then subjected to an intercalation treatment and a delamination treatment.

For example, after the step (b3), the steps (c) to (f) described above may be performed by the second production method.

### Step (g3)

The MXene particles obtained as described above are mixed with a liquid medium to obtain a virus-inactivating liquid agent. Details of the liquid medium are as described above. When the above-described steps (c) to (f) are performed after the step (b3), the same description as the above-described step (g) can be applied to the step (g3).

As described above, a virus-inactivating liquid agent in which the total content of chlorine and bromine in the MXene particles is 1,500 ppm by mass or less can be produced. When the above-described steps (c) to (f) are performed after the step (b3), the content of Li in the MXene particles can be 20 ppm by mass or less.

The contents of chlorine and bromine in the MXene particles can be measured by combustion-ion chromatography.

In the first to third production methods of the present embodiment, an ultrasonic treatment is not performed as delamination after etching. Since the ultrasonic treatment is not performed, particle breakage hardly occurs, and it is possible to obtain a MXene particle including single-layer/few-layer MXene having a large two-dimensional surface.

In the virus-inactivating liquid agent of the present embodiment, the MXene particles may carry at least one of a metal and a metal oxide. This makes it possible to improve the virus inactivation ability and/or to add other functions (antimicrobial properties, catalytic functions, and the like) depending on the carried metal and/or metal oxide. The metal constituting the metal or the metal oxide may be, for example, Ag or the like. When the MXene particles carry a metal, for example, the metal particles may be carried on the MXene particles. When the MXene particles carry the metal oxide, for example, the metal oxide particles may be carried on the MXene particles, or the metal (M) constituting the MXene layer may be partially oxidized to carry the metal oxide (generated by the partial oxidation) on the MXene particles. The fact that the MXene particles carry a metal and/or a metal oxide can be confirmed by detecting a peak specific to MXene and a peak specific to a metal and/or a metal oxide in an XRD profile obtained by subjecting the particles to X-ray diffraction (XRD) measurement. The peak specific to MXene may be a peak on the (001) plane (1 is a natural multiple of 2, that is, 1=2, 4, 6, 8, 10, 12 . . . ) of MXene, particularly on the (002) plane. The detection of a peak specific to the metal and/or metal oxide in the XRD profile means that the content of the metal and/or metal oxide (based on the entire metal and/or metal oxide-carried MXene particles) is several mass % or more.

For example, the MXene particles may carry titanium oxide. When the MXene particles carry titanium oxide, it is possible to add the antibacterial properties to the virus-inactivating liquid agent. In this case, for example, the titanium oxide particles may be carried on the MXene particles, or Ti constituting the MXene layer may be partially oxidized to carry the titanium oxide (generated by the partial oxidation) on the MXene particles. Although the present embodiment is not limited, specifically, the partial oxidation can be performed by heating, for example, at 60 to 80° C. (typically about 70° C.) for 50 to 250 hours (typically 70 to 200 hours) in the presence of oxygen. The titanium oxide is not particularly limited, but may be an anatase type. For example, when the MXene particles are Ti₃C₂T₅, and Ti contained in the MXene particles is partially oxidized to generate TiO₂ to obtain TiO₂-carried Ti₃C₂T₅ particles, in an XRD profile obtained by subjecting the particles to X-ray diffraction (XRD) measurement, a peak of a (002) plane specific to Ti₃C₂T₅ is detected in the vicinity of 2θ=5 to 8°, and a peak specific to anatase TiO₂ is detected in the vicinity of 2θ=24 to 26°, which can be confirmed.

It is to be noted that the partial oxidation in the MXene particles is undesirable from the viewpoint of dispersion stability if it proceeds excessively, but as described above, even if the partial oxidation occurs to some extent, the effect of virus inactivation is not significantly inactivated. Partial oxidation may appropriately proceed according to desired characteristics, applications, and the like of the virus-inactivating liquid agent to achieve both the effect of virus inactivation and antibacterial properties.

### Second Embodiment: Virus-Inactivating Article

Hereinafter, a virus-inactivating article in one embodiment of the present disclosure will be described in detail, but the present disclosure is not limited to such an embodiment.

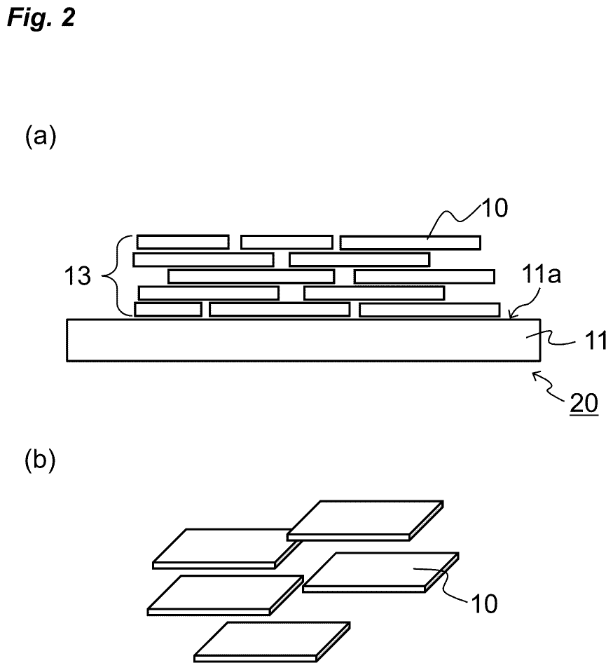

Referring to FIG. 2, a virus-inactivating article 20 of the present embodiment includes a substrate 11, a virus-inactivating layer 13 disposed on the substrate 11, in which the virus-inactivating layer 13 contains particles 10 of a predetermined layered material (MXene).

The substrate 11 may be any suitable article that may be desired to impart a function of virus inactivation. The substrate 11 may also be understood as a support supporting the virus-inactivating layer 13.

The material, form, and the like of the substrate 11 are not particularly limited. For example, the substrate 11 may be made of fiber, glass, a polymer/polymer composition (resin, plastic, or the like), ceramic, metal, or the like.

For example, the substrate 11 may be any one selected from the group consisting of a filter, a mask, a face shield, a bandage, a glove, a gown, a touch panel, a display (including monitors), a film (including protective films), or a sticker. The filter may be a filter used for an air purifier or an air conditioner, a filter (membrane) used for a water purifier or a drainage treatment facility, or the like. A mask, a face shield, a bandage, a glove, a gown, a touch panel, a display, a film, and a sticker may be common. Among them, a mask, a face shield, a bandage, a glove, a gown, a touch panel, and a display can be those for medical use (those used in a medical site), and are suitably used particularly in a case where the mask, the face shield, the bandage, the glove, the gown, the touch panel, and the display are easily exposed to viruses. The film and the sticker may have an adhesive layer on the side opposite to the surface on which the virus-inactivating layer is disposed, and may be attachable to any other article or the like (for example, a touch panel, a display, a portion that may be touched by a large number of humans, and the like) via the adhesive layer. Alternatively, the film may not have an adhesive layer, and may be, for example, a porous film.

In the present embodiment, the virus-inactivating layer 13 can be formed using the virus-inactivating liquid agent described above in the first embodiment. More specifically, the virus-inactivating article 20 of the present embodiment can be produced by (a) applying a virus-inactivating liquid agent onto the substrate 11 to form a precursor of a virus-inactivating layer including particles of MXene, and (b) drying the precursor (in other words, at least partially removing the liquid medium) to form the virus-inactivating layer 13.

The method for applying the virus-inactivating liquid agent onto the substrate 11 in the above (a) is not particularly limited, and for example, spraying, spin casting, a blade method, printing, brushing, dipping, or the like can be used.

The above (a) and (b) may be repeated twice or more in total until a desired virus-inactivating layer thickness is obtained.

The virus-inactivating layer 13 may be substantially formed of only the MXene particles 10 (and the liquid medium that may possibly remain), or may further contain at least one additive (not shown) selected from the group consisting of a dispersant, a binder, an antioxidant, a viscosity modifier, or a perfume, in addition to the MXene particles 10 (and the liquid medium that may possibly remain). In order to obtain a high effect of virus inactivation, when the substrate surface 11a is flat as illustrated in FIG. 2, it is preferable that the MXene particles 10 exist in a state of being oriented as parallel as possible (arranged flat) to the substrate surface 11a to form the virus-inactivating layer 13, but the present invention is not limited thereto. For example, when the substrate surface is not flat (surface roughness is large), the MXene particles 10 may be present in a state of being oriented along the state of the substrate surface to form the virus-inactivating layer 13.

As a result, the surface 11a of the substrate 11 is coated with the virus-inactivating layer 13. The virus-inactivating layer 13 may coat the entire surface of the substrate surface 11a or may coat a part of the substrate surface 11a. The thickness of the virus-inactivating layer 13 can vary depending on the application of the virus-inactivating article 20 and the like, and can be, for example, 0.1 μm to 1 mm.

According to the virus-inactivating article 20 of the present embodiment, the MXene particles can inactivate the virus by a mechanism similar to that described above in the first embodiment, and the effect of virus inactivation can be continuously exhibited for a long time.

Unless otherwise specified in the present embodiment, the same description as that of the first embodiment can be applied to the present embodiment.

### EXAMPLES

### Example 1

Example 1 relates to one example of the virus-inactivating liquid agent described above in the first embodiment.

### [Preparation of Virus-Inactivating Liquid Agent]

In Example 1, as described in detail below, (1) Preparation of the precursor (MAX), (2) Etching of the precursor, (3) Washing, (4) Delamination, and (5) Concentration adjustment were sequentially performed to prepare a virus-inactivating liquid agent.

### (1) Preparation of Precursor (MAX)

TiC powder, Ti powder, and Al powder (all manufactured by Kojundo Chemical Laboratory Co., Ltd.) were placed in a ball mill containing zirconia balls at a molar ratio of 2:1:1 and mixed for 24 hours. The obtained mixed powder was calcined at 1350° C. for 2 hours under an Ar atmosphere. A calcined body (block) thus obtained was pulverized with an end mill to a maximum dimension of not more than 40 μm. In this way, Ti₃AlC₂ particles were obtained as a precursor (MAX).

### (2) Etching of Precursor

Using the Ti₃AlC₂ particles (powder) prepared by the above method, etching was performed under the following etching conditions to obtain a solid-liquid mixture (slurry) containing a solid component derived from the Ti₃AlC₂ powder.

### (Etching Conditions)

Precursor: Ti₃AlC₂ (sieving with a mesh size of 45 μm)
Etching solution composition: Mixture of 3 g of LiF and 30 mL of hydrochloric acid (9 mol/L)
Amount of precursor input: 3.0 g
Etching container: 100 mL Aiboy
Etching temperature: 35° C.
Etching time: 24 h
Stirrer rotation speed: 400 rpm

### (3) Washing

The slurry was divided into three portions, each of which was inserted into three 50 mL centrifuge tubes, centrifuged under the condition of a relative centrifugal force (RCF) of 3500 G (the clay was thereby precipitated) using a centrifuge, and then the supernatant was removed (discarded). An operation of adding 40 mL of pure water to each centrifuge tube (the remainder from which the supernatant liquid was separated and removed was present), centrifuging again at 3500 G, and separating and removing the supernatant was repeated 11 times. Finally, MXene (Ti₃C₂T₅) particle-water medium clay was obtained as the remainder (precipitate) from which the supernatant was separated and removed.

### (4) Delamination

Next, 40 mL of pure water was added to the MXene (Ti₃C₂T₅) particle-moisture medium clay, and the mixture was stirred for 15 minutes with a shaker, then centrifuged at 3500 G, and the supernatant was recovered as a single-layer/few-layer MXene (Ti₃C₂T₅) particle-containing liquid. The average value of the thickness of the MXene particles contained in the single-layer/few-layer MXene (Ti₃C₂T₅) particle-containing liquid was 1 nm to 10 nm (the same applies to the following examples).

### (5) Concentration Adjustment

The single-layer/few-layer MXene (Ti₃C₂T₅) particle-containing liquid was diluted with pure water to adjust the concentration of particles as a solid content to 5 mg/mL, thereby obtaining a virus-inactivating liquid agent.

As described above, a virus-inactivating liquid agent of Example 1 containing single-layer/few-layer MXene (Ti₃C₂T₅) particles at 5 mg/mL in pure water was prepared. The pH of the liquid medium in this virus-inactivating liquid agent was 4.3. In this virus-inactivating liquid agent, it was visually confirmed that particles were well dispersed without aggregation/sedimentation.

### [Evaluation: Inactivation Against Enveloped Virus]

The virus-inactivating liquid agent obtained in Example 1 was used as a specimen (sample), and an inactivation test for enveloped virus of this specimen was performed to evaluate the virus inactivation ability. An influenza virus was used as an enveloped virus. Details of the test are as follows.

### (1) Viruses and the Like Used in the Test

### Test Virus:

Influenza A virus (H1N1) A/PR/8/34 ATCC VR-1469

### Cells Used:

MDCK (NBL-2) cell JCRB 9029 strain

### Medium Used:

### Cell Growth Medium

An Eagle's MEM medium “NISSUI” (1) (manufactured by Shimadzu Diagnostics Corporation.) added with 10% fetal bovine serum was used.

### Cell Maintenance Medium

One having the following composition was used.

| | |
|---|---|
| Eagle's MEM medium “Nissui” (1) | 100 mL |
| 10% sodium bicarbonate | 14 mL |
| L-glutamine (30 g/L) | 9.8 mL |
| Vitamin solution for MEM (100×) | 30 mL |
| 10% albumin | 20 mL |
| 0.25% trypsin | 20 mL |

### (2) Preparation of Virus Fluid

### Cell Culture

In the flask for cell culture, the used cells were cultured in a single-layer manner using the cell growth medium.

### Inoculation of Virus

After single-layer culture, the cell growth medium was removed from the inside of the flask, and the test virus was inoculated. Next, the cell maintenance medium was added, and the cells were cultured for 1 to 5 days in a carbon dioxide incubator (CO₂ concentration: 5%) at 37° C.±1° C.

### Preparation of Virus Fluid

After the above culture, the morphology of the cells was observed using an inverted phase contrast microscope, and it was confirmed that morphological change (cytopathic effect) occurred in the cells. Next, a culture solution was centrifuged (3,000 rpm, 10 minutes), and the supernatant was separated and recovered. The obtained supernatant was diluted 10 times with purified water to obtain a virus fluid.

### (3) Test Operation

0.1 mL of the virus fluid was added to 1 mL of a specimen (virus-inactivating liquid agent) and mixed to obtain a mixed liquid (hereinafter, referred to as “working liquid”).

The working liquid was allowed to act by being maintained at room temperature, and after 1 minute, 5 minutes, 15 minutes, and 24 hours from the start, the working liquid was diluted 1,000 times with a cell maintenance medium, and a viral infectivity titer was measured. (in the preliminary test, it was confirmed in advance that the viral infectivity titer can be measured without being affected by the specimen by diluting the working liquid 1,000 times with the cell maintenance medium.)

In addition, the same test was performed using purified water as a control, and the viral infectivity titer was measured at the start (immediately after the start) and after 1 minute, 5 minutes, 15 minutes, and 24 hours from the start.

### (4) Determination of Viral Infectivity Titer

In a microplate for tissue culture (96 holes), the used cells were cultured in a single-layer manner using a cell growth medium, then the cell growth medium was removed, and 0.1 mL of a cell maintenance medium was added (to each hole). Next, the working liquid after the 100 fold dilution and the control were diluted stepwise by 10 fold using a cell maintenance medium. 0.1 mL of the obtained diluted solution was inoculated into 4 holes for each dilution ratio, and cultured in a carbon dioxide incubator (CO₂ concentration: 5%) at 37° C.±1° C. for 4 to 7 days.

After the above culture, the presence or absence of morphological change (cytopathic effect) of the cells was observed using an inverted phase contrast microscope, and the 50% tissue culture infectious dose (TCID₅₀) was calculated by Reed-Muench method and converted to a viral infectivity titer per 1 mL of the working liquid (logo TCID₅₀/mL).

The measurement results of the viral infectivity titer (log₁₀ TCID₅₀/mL) are shown in Table 1.

TABLE 1

| | log₁₀ TCID₅₀/mL | | | | |
|---|---|---|---|---|---|
| | Start | 1 minute | 5 minutes | 15 minutes | 24 hours |
| Specimen | — | <3.5 | <3.5 | <3.5 | <3.5 |
| Control | 6.5 | 6.3 | 6.5 | 6.3 | 6 |

In the table, “<3.5” indicates that it was less than the lower detection limit (no viral infection was detected).

As understood from Table 1, it was confirmed that the viral infectivity titer of the virus-inactivating liquid agent (specimen) of Example 1 was below the lower detection limit in only 1 minute from the start of action, and the virus was inactivated in a short time. Furthermore, it was confirmed that the virus-inactivating liquid agent (specimen) of Example 1 had a viral infectivity titer below the lower detection limit even 24 hours after the start of action, and was capable of continuously inactivating viruses. These results showed that the virus-inactivating liquid agent of Example 1 had high virus inactivation ability against enveloped virus.

### [Evaluation: Inactivation Against Non-Enveloped Virus]

It is considered that the virus-inactivating liquid agent of Example 1 has high virus inactivation ability even against non-enveloped viruses.

### Example 2

Example 2 relates to a modification of Example 1.

### [Preparation of Virus-Inactivating Liquid Agent]

In Example 2, as described in detail below, after (4) Delamination of Example 1, partial oxidation was performed as an additional step, and thereafter, (5′) Concentration adjustment was performed to prepare a virus-inactivating liquid agent.

First, the same operations as (1) Preparation of precursor (MAX), (2) Etching of precursor, (3) Washing, and (4) Delamination described in detail in Example 1 were performed to obtain a single-layer/few-layer MXene (Ti₃C₂T₅) particle-containing liquid.

In the single-layer/few-layer MXene (Ti₃C₂T₅) particle-containing liquid thus obtained, the concentration of particles as a solid content was 125 mg/mL.

### (Additional Step) Partial Oxidation

The single-layer/few-layer MXene (Ti₃C₂T₅) particle-containing liquid was subjected to a heat treatment (oxidation treatment) at 70° C. in an environment containing oxygen and having a relative humidity of 90% to obtain a treatment liquid. The treatment time was 194.5 hours.

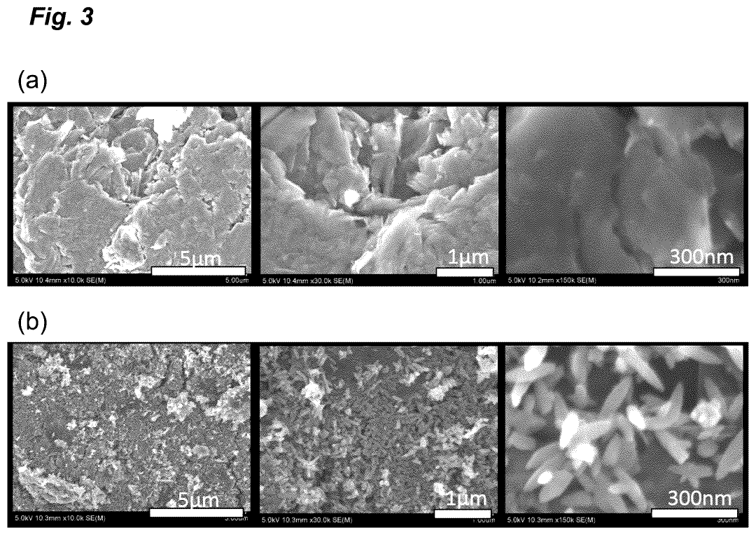

In order to confirm that the partial oxidation proceeded in the heat treatment (oxidation treatment), a solid content (particle) was collected from each of the single-layer/few-layer MXene (Ti₃C₂T₅) particle-containing liquid (before treatment) and the treatment liquid (after treatment), and observed with a scanning electron microscope (SEM). The obtained SEM photograph is illustrated in FIG. 3. As compared with the state before the treatment illustrated in FIG. 3(a), in the state after the treatment illustrated in FIG. 3(b), an elongated image specific to TiO₂ obtained by low temperature oxidation (observed as particles of a white elongated image in the SEM photograph) was observed. The solid content (particles) was subjected to X-ray diffraction (XRD) measurement to obtain an XRD profile. As compared with the XRD pattern of the solid content (particles) before the treatment, in the XRD pattern of the solid content (particles) after the treatment, the height of the peak around 2θ=5 to 8° unique to Ti₃C₂T₅ decreased, and a peak around 2θ=24 to 26° unique to anatase TiO₂ was newly detected.

### (5′) Concentration Adjustment

The treatment liquid after the heat treatment (oxidation treatment) was diluted with pure water, and the concentration of particles as a solid content was adjusted to 5 mg/mL to obtain a virus-inactivating liquid agent.

As described above, a virus-inactivating liquid agent of Example 2 containing single-layer/few-layer MXene (Ti₃C₂T₅) particles carried with TiO₂ at 5 mg/mL in pure water was prepared. The pH of the liquid medium in this virus-inactivating liquid agent was 4.3. In this virus-inactivating liquid agent, it was visually confirmed that particles were well dispersed without aggregation/sedimentation.

### [Evaluation: Inactivation Against Enveloped Virus]

The virus-inactivating liquid agent obtained in Example 2 was used as a specimen (sample), and an inactivation test for enveloped virus of this specimen was performed in the same manner as in Example 1 to evaluate the virus inactivation ability. These results thus obtained showed that the virus-inactivating liquid agent of Example 2 had high virus inactivation ability against enveloped virus.

### [Evaluation: Inactivation Against Non-Enveloped Virus]

It is considered that the virus-inactivating liquid agent of Example 2 has high virus inactivation ability even against non-enveloped viruses.

### Example 3

Example 3 relates to the virus-inactivating article described above in the second embodiment.

### [Production of Virus-Inactivating Article]

In Example 3, as described in detail below, a virus-inactivating liquid agent was applied onto a substrate to form a virus-inactivating layer, thereby producing a virus-inactivating article in which the virus-inactivating layer was disposed on the substrate.

First, a virus-inactivating liquid agent containing single-layer/few-layer MXene (Ti₃C₂T₅) particles in pure water at 34 mg/mL was prepared in the same manner as in Example 1 except that the dilution with pure water was changed in the concentration adjustment in the above (5).

In this virus-inactivating liquid agent, the average value of the thickness of the MXene particles was 1 nm to 10 nm, and the average dimension of the MXene particles in the two-dimensional sheet plane was 3 μm.

The virus-inactivating liquid agent was a dispersion liquid in which MXene (Ti₃C₂T₅) particles were dispersed in pure water, and did not contain additives such as a binder and a dispersant.

Separately, a glass substrate whose surface was hydrophilized by UV treatment was prepared as a substrate.

Then, the operation of spraying the virus-inactivating liquid agent prepared above onto the hydrophilized surface of the glass substrate and then blowing hot air with a dryer was repeated 30 times, and then the glass substrate was further subjected to preliminary drying at 80° ° C. for 2 hours in an atmospheric pressure oven and main drying at 150° C. for 18 hours in a vacuum oven (pure water as a liquid medium was substantially removed by drying.). With this, a virus-inactivating layer formed of single-layer/few-layer MXene (Ti₃C₂T₅) particles was formed on the hydrophilized surface of the glass substrate. The thickness of the virus-inactivating layer was about 2 μm.

As described above, the virus-inactivating article of Example 3 in which the virus-inactivating layer formed of single-layer/few-layer MXene (Ti₃C₂T₅) particles was disposed on a glass substrate was obtained.

### [Evaluation: Inactivation Against Enveloped Virus]

The virus-inactivating article of Example 3 is considered to have high virus inactivation ability against enveloped virus.

### [Evaluation: Inactivation Against Non-Enveloped Virus]

It is considered that the virus-inactivating article of Example 3 has high virus inactivation ability even against non-enveloped viruses.

### Example 4

Example 1 relates to another example of the virus-inactivating liquid agent described above in Embodiment 4.

In Example 4, as described in detail below, (1) Preparation of the precursor (MAX), (2) Etching of the precursor, (3) Washing after etching, (4) Intercalation of Li, and (5) Delamination were sequentially performed to prepare a virus-inactivating liquid agent.

### (1) Preparation of Precursor (MAX)

Similar to Example 1, Ti₃AlC₂ particles were obtained as a precursor (powdery MAX).

### (2) Etching of Precursor

A solid-liquid mixture (slurry) containing a solid component derived from a Ti₃AlC₂ powder was obtained in the same manner as in Example 1 except that the etching solution composition under the etching conditions was as follows.

### Etching Solution Composition:

| | |
|---|---|
| 49% HF | 6 mL |
| H₂O | 18 mL |
| HCl (12M) | 36 mL |

(3) Washing after Etching

A MXene (Ti₃C₂T₅) particle-water medium clay was obtained in the same manner as in Example 1 except that the slurry was divided into two and inserted into two 50 mL centrifuge tubes, respectively.

### (4) Intercalation of Li

The MXene (Ti₃C₂T₅) particle-moisture medium clay prepared by the above method was stirred according to the following conditions to perform intercalation of Li.

### (Conditions of Intercalation of Li)

### Composition of Preparation:

MXene (Ti₃C₂T₅) particle-moisture medium clay: Solid content 0.75 g

| | |
|---|---|
| LiCl | 1.00 g |
| HCl | About 0.67 g |
| Pure water | 19.42 g |

Intercalation container: 100 mL Aiboy
Temperature: 20° C. or higher and 25° ° C. or lower (room temperature)
Time: 12 h
Stirrer rotation speed: 800 rpm

### (5) Delamination

The slurry obtained by Li intercalation was charged into a 50 mL centrifuge tube, centrifuged under the condition of 3500 G using a centrifuge, and then the supernatant was discarded. Next, (i) 40 mL of pure water was added to the remaining precipitate, and the mixture was stirred for 15 minutes with a shaker, then (ii) centrifuged at 3500 G, and (iii) the supernatant was recovered as a single-layer/few-layer MXene-containing liquid. The operations (i) to (iii) were repeated 4 times in total to obtain a single-layer/few-layer MXene-containing supernatant. Further, this supernatant was centrifuged under the conditions of 4300 G and 2 hours using a centrifuge, and then the supernatant was discarded to obtain a single-layer/few-layer MXene-containing clay. 1 mg of the clay thus obtained was redispersed in 10 mL of pure water.

As described above, a virus-inactivating liquid agent of Example 4 containing single-layer/few-layer MXene (Ti₃C₂T₅) particles at about 3 mg/mL in pure water was prepared. The pH of the liquid medium in this virus-inactivating liquid agent was 2.7. In this virus-inactivating liquid agent, it was visually confirmed that particles were well dispersed without aggregation/sedimentation.

### Example 5

Example 2 relates to a modification of Example 4.

In Example 5, a virus-inactivating liquid agent was prepared in the same manner as in Example 4 except that in the (4) Intercalation of Li, the composition of preparation under the conditions of the intercalation of Li was as follows.

### Composition of Preparation:

MXene (Ti₃C₂T₅) particle-moisture medium clay: Solid content 0.75 g

| | |
|---|---|
| LiCl | 0.97 g |
| LiOH + H₂O | About 0.03 g |
| Pure water | 20.00 g |

As described above, a virus-inactivating liquid agent of Example 5 containing single-layer/few-layer MXene (Ti₃C₂T₅) particles at about 2 mg/mL in pure water was prepared. The pH of the liquid medium in this virus-inactivating liquid agent was 6.9. In this virus-inactivating liquid agent, it was visually confirmed that particles were well dispersed without aggregation/sedimentation.

### Example 6

Example 6 relates to still another example of the virus-inactivating liquid agent described above in the first embodiment.

In Example 6, the same procedure as in Example 4 was performed except that, in the (4) Intercalation of Li, the preparation composition under the conditions of the intercalation of Li was changed as follows, and the following (5′) Delamination was performed instead of the (5) Delamination. Thereafter, (6) Acid treatment and (7) Water washing were performed in this order to prepare a virus-inactivating liquid agent.

### (Conditions of Intercalation of Li)

### Composition of Preparation:

MXene (Ti₃C₂T₅) particle-moisture medium clay: Solid content 0.75 g
LiCl 0.75 g

### (5′) Delamination

The slurry obtained by Li intercalation was charged into a 50 mL centrifuge tube, centrifuged under the condition of 3500 G using a centrifuge, and then the supernatant was discarded. Next, (i) 40 mL of pure water was added to the remaining precipitate, and the mixture was stirred for 15 minutes with a shaker, then (ii) centrifuged at 3500 G, and (iii) the supernatant was recovered as a single-layer/few-layer MXene-containing liquid. The operations (i) to (iii) were repeated 4 times in total to obtain a single-layer/few-layer MXene-containing supernatant. Further, this supernatant was centrifuged under the conditions of 4300 G and 2 hours using a centrifuge, and then the supernatant was discarded to obtain a single-layer/few-layer MXene-containing clay.

### (6) Acid Treatment

(i) 35 mL of 1.8 M hydrochloric acid was added to the single-layer/few-layer MXene-containing clay, then the mixture was stirred with a shaker for 5 minutes, then (ii) centrifuged at 3500 G, and (iii) the supernatant was discarded. The operations (i) to (iii) were repeated 5 times in total.

### (7) Water Washing

(i) 35 mL of water was added to the single-layer/few-layer MXene-containing clay after acid treatment, then the mixture was stirred with a shaker for 5 minutes, then (ii) centrifuged at 3500 G, and (iii) the supernatant was discarded. The operations (i) to (iii) were repeated 5 times in total to obtain a single-layer/few-layer MXene-containing clay as a single-layer/few-layer MXene-containing sample. It was confirmed that the pH of the supernatant was finally 4 or more. 1 mg of the clay thus obtained was redispersed in 10 mL of pure water.

As described above, a virus-inactivating liquid agent of Example 6 containing single-layer/few-layer MXene (Ti₃C₂T₅) particles at about 3 mg/mL in pure water was prepared. The pH of the liquid medium in this virus-inactivating liquid agent was 4.3. In this virus-inactivating liquid agent, it was visually confirmed that particles were well dispersed without aggregation/sedimentation.

### [Measurement of Li Content in MXene Particles]

MXene was made into a solution by an alkali melting method, and the Li content was measured by ICP-AES (iCAP 7400 manufactured by Thermo Fisher Scientific was used) using inductively coupled plasma emission spectrometry. As a result, the Li content was 4 ppm by mass.

### Example 7

Example 7 relates to still another example of the virus-inactivating liquid agent described above in the first embodiment.

In Example 7, as described in detail below, (1) Preparation of the precursor (MAX), (2) Etching of the precursor, (3) Washing after etching, (4) Intercalation of Li, and (5) Delamination were sequentially performed to prepare a virus-inactivating liquid agent.

### (1) Preparation of Precursor (MAX)

Similar to Example 1, Ti₃AlC₂ particles were obtained as a precursor (powdery MAX).

### (2) Etching of Precursor

A solid-liquid mixture (slurry) containing a solid component derived from a Ti₃AlC₂ powder was obtained in the same manner as in Example 1 except that the etching solution composition under the etching conditions was as follows.

### (Etching Conditions)

### Etching Solution Composition:

| | |
|---|---|
| HF concentration | 2.8M |
| H₃PO₄ concentration | 7.4M |

(3) Washing after Etching

A MXene (Ti₃C₂T₅) particle-water medium clay was obtained in the same manner as in Example 1 except that the slurry was divided into two and inserted into two 50 mL centrifuge tubes, respectively.

### (4) Intercalation of Li

Li₃PO₄, H₃PO₄, and pure water were added to the MXene (Ti₃C₂T₅) particle-moisture medium clay prepared by the above method, and the mixture was stirred at a predetermined temperature range for a predetermined time to perform Li of intercalation.

### (Conditions of Li Intercalation)

### Composition of Preparation:

MXene (Ti₃C₂T₅) particle-moisture medium clay: Solid content 0.75 g
Li₃PO₄: 0.68 g
85% by mass of H₃PO₄: 3.1 mL
Pure water: 31.9 mL
Intercalation container: 100 mL Aiboy
Temperature: 20° C. or higher and 25° C. or lower (room temperature)
Time: 15 h
Stirrer rotation speed: 800 rpm

### (5) Delamination

The slurry obtained by Li intercalation was charged into a 50 mL centrifuge tube, centrifuged under the condition of 3500 G using a centrifuge, and then the supernatant was discarded. Subsequently, an operation of adding 40 mL of pure water to the remaining precipitate from which the supernatant was removed, stirring the mixture with a shaker for 15 minutes, then centrifuging the mixture at 3500 G, and recovering the supernatant as a single-layer/few-layer MXene-containing liquid was repeated 4 times to obtain a single-layer/few-layer MXene-containing liquid product.

As described above, a virus-inactivating liquid agent of Example 7 containing single-layer/few-layer MXene (Ti₃C₂T₅) particles at about 3 mg/mL in pure water was prepared. The pH of the liquid medium in this virus-inactivating liquid agent was 4.3. In this virus-inactivating liquid agent, it was visually confirmed that particles were well dispersed without aggregation/sedimentation.

### [Measurement of Chlorine Content and Bromine Content in MXene Particles]

The chlorine content and the bromine content in MXene particles obtained in Example 7 were measured using a combustion-ion chromatography apparatus (Dionex ICS-5000) manufactured by Thermo Fisher Scientific. As a result, the chlorine content was 50 ppm by mass or less, and the bromine content was 50 ppm by mass or less, that is, the total content of chlorine and bromine was 100 ppm by mass or less.

### [Evaluation: Inactivation Against Virus]

It is considered that the virus-inactivating liquid agent of Examples 4 to 7 has high virus inactivation ability even against enveloped virus and non-enveloped virus, similarly to the virus-inactivating liquid agent of Example 1.

The virus-inactivating liquid agent and the virus-inactivating article of the present disclosure can inactivate a virus, and thus can be used to prevent humans and other organisms from being infected with the virus.

### EXPLANATION OF REFERENCES

1a, 1b Layer body (MₘXₙ layer)
3a, 5a, 3b, 5b Modifier or terminal T
7a, 7b MXene layer
10, 10a, 10b MXene (layered material) particles
11 Substrate
11a Substrate surface
13 Virus-inactivating layer
20 Virus-inactivating article

1. A virus-inactivating liquid agent comprising:
a liquid medium; and
particles of a layered material including one or plural layers, wherein the one or plural layers include a layer body represented by: 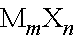
wherein M is at least one first metal of Group 3, 4, 5, 6, or 7,
X is a carbon atom, a nitrogen atom, or a combination thereof,
n is 1 to 4, and
m is more than n and 5 or less, and
a modifier or terminal T exists on a surface of the layer body, and T is at least one selected from the group consisting of a hydroxyl group, a fluorine atom, a chlorine atom, or an oxygen atom, and
wherein an average value of thicknesses of the particles is 10 nm or less.

2. The virus-inactivating liquid agent according to claim 1, wherein the MₘXₙ is Ti₃C₂.

3. The virus-inactivating liquid agent according to claim 1, wherein the average value of the thicknesses of the particles is 1 nm to 10 nm.

4. The virus-inactivating liquid agent according to claim 1, wherein the liquid medium contains at least one of water and an alcohol.

5. The virus-inactivating liquid agent according to claim 1, further comprising at least one additive selected from the group consisting of a dispersant, a binder, an antioxidant, a viscosity modifier, or a perfume.

6. The virus-inactivating liquid agent according to claim 1, wherein a content of the particles in the virus-inactivating liquid agent is 0.5 mg/mL to 100 mg/mL.

7. The virus-inactivating liquid agent according to claim 1, wherein the liquid medium has a pH of 2.7 to 7.0.

8. The virus-inactivating liquid agent according to claim 1, wherein the particles further include Li, and a content of the Li in the particles is 20 ppm by mass or less.

9. The virus-inactivating liquid agent according to claim 1, wherein a total content of chlorine and bromine in the particles is 1,500 ppm by mass or less.

10. The virus-inactivating liquid agent according to claim 1, wherein the particles carry at least one of a second metal and a metal oxide.

11. The virus-inactivating liquid agent according to claim 1, wherein the particles carry titanium oxide.

12. A virus-inactivating article comprising:
a substrate; and
a virus-inactivating layer on the substrate, wherein the virus-inactivating layer includes particles of a layered material including one or plural layers, the one or plural layers including a layer body represented by: 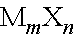
wherein M is at least one first metal of Group 3, 4, 5, 6, or 7,
X is a carbon atom, a nitrogen atom, or a combination thereof,
n is 1 to 4, and
m is more than n and 5 or less, and
a modifier or terminal T exists on a surface of the layer body, and T is at least one selected from the group consisting of a hydroxyl group, a fluorine atom, a chlorine atom, or an oxygen atom, and
wherein an average value of thicknesses of the particles is 10 nm or less.

13. The virus-inactivating article according to claim 12, wherein the substrate is any one selected from the group consisting of a filter, a mask, a face shield, a bandage, a glove, a gown, a touch panel, a display, a film, or a sticker.

14. The virus-inactivating article of claim 12, wherein the MₘXₙ is Ti₃C₂.

15. The virus-inactivating article according to claim 12, wherein the average value of the thicknesses of the particles is 1 nm to 10 nm.

16. The virus-inactivating article according to claim 12, further comprising at least one additive selected from the group consisting of a dispersant, a binder, an antioxidant, a viscosity modifier, or a perfume.

17. The virus-inactivating article according to claim 12, wherein the particles further include Li, and a content of Li in the particles is 20 ppm by mass or less.

18. The virus-inactivating article according to claim 12, wherein a total content of chlorine and bromine in the particles is 1,500 ppm by mass or less.

19. The virus-inactivating article according to claim 12, wherein the particles carry at least one of a second metal and a metal oxide.

20. The virus-inactivating article according to claim 12, wherein the particles carry titanium oxide.
